(19) United States
(12) Patent Application Publication
(10) Pub. No.: US 2026/0329651 A1
(43) Pub. Date: Oct. 22, 2026

(54) Hybrid I/O Management Architecture with Tiered Dispatch

(71) Applicant: Oracle International Corporation, Redwood Shores, CA (US)

(72) Inventor: Rajarshi Chowdhury, San Jose, CA (US)

(73) Assignee: Oracle International Corporation, Redwood Shores, CA (US)

(21) Appl. No.: 19/339,611

(22) Filed: Sep. 25, 2025

(51) Int. Cl. G06F 9/50; G06F 11/34

(52) U.S. Cl. CPC G06F 9/5033; G06F 9/5038; G06F 11/3419

(57) ABSTRACT

Techniques for managing input/output (I/O) requests in a computing system are disclosed. The system receives I/O requests and assigns requests to one of several tiers. The system then routes a request to a tier best suited for the request. The tier may be selected based on an explicit request from the application sending the I/O request or based on system conditions. The system executes I/O operations using a kernel interface having submission and completion queues. The system can adjust execution paths if system conditions change and may reassign I/O requests from one tier to another. The system offers several tiers for managing I/O operations: a critical tier for low-latency asynchronous I/O, a tier for blocking I/O without polling, a tier for I/O completion polling, and a tier for fully asynchronous I/O without polling. These tiers offer different benefits and system resource trade-offs, allowing for fine-grained control over I/O resource allocation.

### TECHNICAL FIELD

The present disclosure relates to computer systems. In particular, the present disclosure relates to Input/Output (I/O) management systems.

### BACKGROUND

In the field of computer systems, I/O operations enable communication between applications and devices. I/O operations allow applications to read and write data to devices, such as storage devices, network devices, and other peripherals. I/O management involves the use of a kernel or operating system to manage I/O operations. The kernel provides a layer of abstraction between applications and devices, allowing applications to access devices without needing to know the details of the devices. The kernel uses various methods to optimize I/O operations and improve system performance.

I/O management systems typically involve the kernel managing I/O operations on behalf of applications. The kernel receives I/O requests from applications and manages the I/O operations, providing the results to the applications. The kernel may use various data structures, such as queues, to manage I/O requests and provide efficient access to devices. I/O management systems may be used in a variety of applications, including database systems, file systems, and network systems. The kernel may provide a set of APIs or system calls that applications can use to interact with devices.

I/O operations are a fundamental aspect of computer systems, and I/O management plays a key role in determining the performance and responsiveness of applications. I/O management systems may be designed to support different types of devices, such as block devices, character devices, or network devices. The kernel may provide a set of features, such as I/O scheduling and I/O prioritization, to optimize I/O operations. I/O management systems may be used to improve the performance and efficiency of I/O operations and may be used in a variety of systems, including servers, desktops, and mobile devices. The kernel may be designed to support different types of applications, such as real-time applications or high-performance applications. I/O management systems may be used to provide efficient and scalable I/O operations and may be used in a variety of industries, including finance, healthcare, and entertainment.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an I/O dispatcher in accordance with one or more embodiments;

FIG. 2 illustrates an example set of operations for efficiently managing I/O in a system in accordance with one or more embodiments;

FIG. 3 illustrates an example set of operations for efficiently managing I/O in a system in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. I/O MANAGEMENT ARCHITECTURE
3. EFFICIENT I/O MANAGEMENT
4. EXAMPLE EMBODIMENT
5. PRACTICAL APPLICATIONS, ADVANTAGES, AND IMPROVEMENTS
6. COMPUTER NETWORKS AND CLOUD NETWORKS
7. HARDWARE OVERVIEW
8. MISCELLANEOUS; EXTENSIONS

### 1. General Overview

One or more embodiments manage Input/Output (I/O) operations in a computing system. The system receives I/O requests and assigns requests to one of several tiers. The system then routes a request to a tier that is best suited for the request. The tier may be selected based on an explicit request from the application sending the I/O request, or the tier may be selected based on system conditions. The system executes I/O operations using a kernel interface that has submission and completion queues. The system can adjust execution paths if system conditions change, and the system may reassign I/O requests from one tier to another. Embodiments provide a range of tiers for managing I/O operations, including a critical tier for low-latency asynchronous I/O, a tier for blocking I/O without polling, a tier for I/O completion polling, and a tier for fully asynchronous I/O without polling. These tiers offer different benefits and system resource trade-offs, allowing for fine-grained control over I/O resource allocation.

One or more embodiments described in this Specification and/or recited in the claims may not be included in this General Overview section.

### 2. I/O Management Architecture

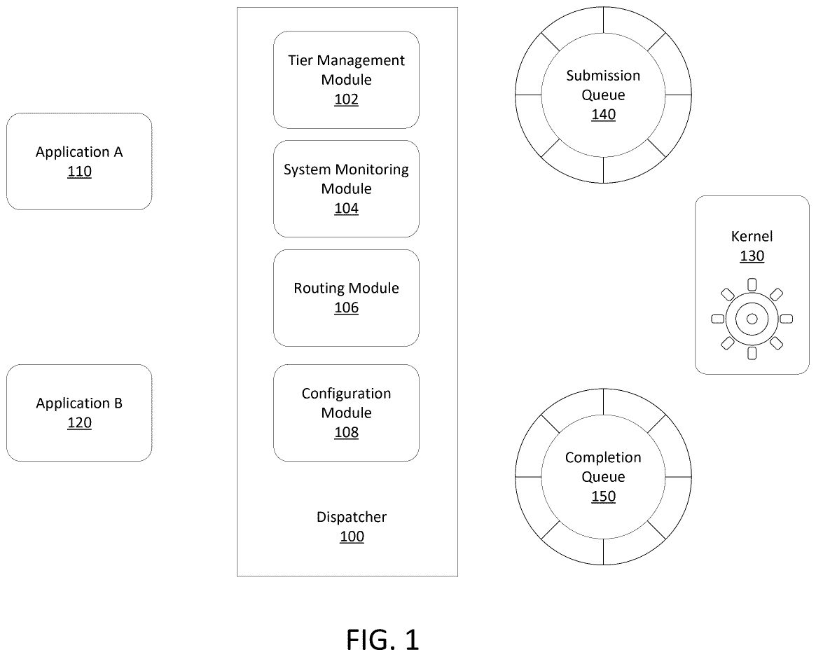

FIG. 1 illustrates an I/O dispatcher in accordance with one or more embodiments. As illustrated in FIG. 1, dispatcher 100 includes tier management module 102, system monitoring module 104, routing module 106, and configuration module 108. In one or more embodiments, dispatcher 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, dispatcher 100 comprises a system component that manages I/O operations. Dispatcher 100 receives I/O requests from applications, such as application 110 and application 120. Dispatcher 100 determines the optimal execution path for I/O requests based on predefined criteria. Dispatcher 100 interacts with kernel 130 to submit I/O requests to the device. Dispatcher 100 supports multiple applications with different I/O requirements. Dispatcher 100 may prioritize I/O operations from different applications based on their requirements.

In an embodiment, dispatcher 100 interacts with submission queue 140 to submit I/O requests to kernel 130. Submission queue 140 is a data structure that stores I/O requests submitted by dispatcher 100. Kernel 130 uses submission queue 140 to manage I/O requests. Dispatcher 100 may use various scheduling algorithms to prioritize I/O operations. Dispatcher 100 submits I/O requests to kernel 130 that then submits the I/O requests to the device. Kernel 130 supports both synchronous and asynchronous I/O operations. Dispatcher 100 may be implemented as a software component, a hardware component, or both.

In an embodiment, dispatcher 100 retrieves the results of I/O operations from completion queue 150. Completion queue 150 is a data structure that stores the results of I/O operations. Kernel 130 uses completion queue 150 to notify dispatcher 100 of I/O completion. Dispatcher 100 interacts with completion queue 150 to determine the status of I/O operations. Dispatcher 100 may use the results of I/O operations to inform future I/O requests. Dispatcher 100 may be used in a variety of systems, including database systems, file systems, and network systems. Dispatcher 100 may be configured to support different types of devices, such as storage devices or network devices. Dispatcher 100 may be used to improve the performance and efficiency of I/O operations. Dispatcher 100 may reduce the latency and increase the throughput of I/O operations. Dispatcher 100 may be used in systems that require high-performance I/O operations. Dispatcher 100 may be used in systems that require low-latency I/O operations. Dispatcher 100 may be used in systems that require both high-performance and low-latency I/O operations.

In an embodiment, tier management module 102 comprises a component that manages different tiers of I/O operations. Tier management module 102 is configured to determine the tier for an I/O operation based on predefined criteria. The tier management module 102 may use system monitoring module 104 to gather information about system resources and make informed decisions about tier allocation. The tier management module 102 interacts with routing module 106 to route I/O operations to the correct tier. The tier management module 102 may be used to optimize I/O operations for different types of applications.

In an embodiment, tier management module 102 is configured to support multiple tiers of I/O operations. The tier management module 102 may be used to manage I/O operations for different devices, such as storage devices or network devices. The tier management module 102 may be used to optimize I/O operations for different types of data, such as sequential or random data. The tier management module 102 interacts with configuration module 108 to determine the optimal tier for I/O operations. The tier management module 102 may use various algorithms to prioritize I/O operations and allocate resources.

In an embodiment, tier management module 102 is configured to dynamically adjust the tier allocation based on system resources. The tier management module 102 may use system monitoring module 104 to monitor system resources and adjust the tier allocation accordingly. The tier management module 102 may be used to optimize I/O operations for systems with limited resources. The tier management module 102 may be used to optimize I/O operations for systems with varying workloads. The tier management module 102 interacts with routing module 106 to ensure that I/O operations are routed to the correct tier. The tier management module 102 may be used to support different types of I/O operations, such as synchronous or asynchronous I/O.

In an embodiment, system monitoring module 104 comprises a component that monitors system resources that impact I/O operations. System monitoring module 104 is configured to gather information about CPU usage, memory usage, and network usage. The system monitoring module 104 may use various techniques to monitor system resources, such as polling or interrupt-driven monitoring. The system monitoring module 104 provides information to tier management module 102 to help determine the optimal tier for I/O operations.

In an embodiment, system monitoring module 104 monitors disk usage and storage capacity. The system monitoring module 104 may track the amount of free disk space, the number of pending I/O requests, and the average response time of the disk. The system monitoring module 104 may also monitor the storage capacity of the disk, including the amount of used and free space. This information may be used by tier management module 102 to adjust the tier allocation for I/O operations.

In an embodiment, system monitoring module 104 monitors network resources, such as bandwidth usage and latency. The system monitoring module 104 may track the amount of data transmitted over the network, the average response time of the network, and the number of pending network requests. The system monitoring module 104 may also monitor the network topology and configuration, including the number of network devices and the type of network connections. This information may be used by tier management module 102 to adjust the tier allocation for I/O operations that involve network communication.

In an embodiment, system monitoring module 104 monitors other system resources, such as power consumption and temperature. The system monitoring module 104 may track the power consumption of the system, including the power usage of individual components. The system monitoring module 104 may also monitor the temperature of the system, including the temperature of individual components. This information may be used by tier management module 102 to adjust the tier allocation for I/O operations to minimize power consumption or prevent overheating. The system monitoring module 104 may also monitor other system resources, such as the number of active processes or the amount of available memory.

In an embodiment, routing module 106 comprises a component that routes I/O requests to the correct execution path. Routing module 106 is configured to receive I/O requests from tier management module 102 and direct them to the appropriate execution path. The routing module 106 may support different execution paths, including synchronous and asynchronous execution paths. The routing module 106 may also support different modes of operation, such as blocking and non-blocking modes.

In an embodiment, routing module 106 is configured to handle execution paths that hand control back to the requesting application. In this mode, the routing module 106 submits the I/O request to the kernel and then returns control to the application, allowing the application to continue executing other tasks. The routing module 106 may use synchronization primitives, such as semaphores or mutexes, to coordinate with the application and ensure that the I/O request is completed correctly. The routing module 106 may also use callbacks or other notification mechanisms to inform the application of I/O completion.

In an embodiment, routing module 106 is configured to handle execution paths where it retains control until completion. In this mode, the routing module 106 submits the I/O request to the kernel and then waits for completion, retaining control until the I/O request is completed. The routing module 106 may use various techniques to wait for completion, such as polling or interrupt-driven waiting. The routing module 106 may also use synchronization primitives to coordinate with the kernel and ensure that the I/O request is completed correctly.

In an embodiment, routing module 106 is configured to support different modes of operation, including blocking and non-blocking modes. In blocking mode, the routing module 106 waits for completion of the I/O request before returning control to the application. In non-blocking mode, the routing module 106 returns control to the application immediately, allowing the application to continue executing other tasks. The routing module 106 may use various algorithms to determine the optimal execution path and mode of operation for I/O requests. The routing module 106 may also use configuration information from configuration module 108 to inform its decisions. The routing module 106 interacts with submission queue 140 and completion queue 150 to manage I/O requests and retrieve results.

In an embodiment, configuration module 108 comprises a component that stores and manages configuration information for the system. Configuration module 108 is configured to store information about the system resources, such as the number of CPUs, the amount of memory, and the type of storage devices. The configuration module 108 may also store information about the I/O requests, such as the priority of the requests, the type of data being transferred, and the deadline for completion. The configuration module 108 provides this information to other components in the system, such as tier management module 102 and routing module 106.

In an embodiment, configuration module 108 is configured to store threshold values for system resources. For example, the configuration module 108 may store a threshold value for CPU usage that may be used as a trigger for the system to switch to a different tier. The configuration module 108 may also store threshold values for memory usage, disk usage, and network usage. These threshold values are used by tier management module 102 to determine the optimal tier for I/O operations. The configuration module 108 may also store information about the optimal configuration for each tier such as the number of I/O requests to allow for each tier.

In an embodiment, configuration module 108 is configured to store information about the I/O paths and devices in the system. For example, the configuration module 108 may store the execution path for each tier, describing the commands, options, and flags that are invoked. In addition, configuration module 108 may include settings for each tier or execution path to determine if or when the dispatcher 100 passes control of the I/O operation back to a requesting application. The configuration module 108 may store information about the devices that are available, their capacities, and their performance characteristics. The configuration module 108 may also store information about the I/O paths, such as the bandwidth and latency of each path. This information is used by routing module 106 to determine the optimal execution path for the I/O requests. The configuration module 108 may also store information about the system's network topology, including the number of network devices and the type of network connections.

In an embodiment, configuration module 108 is configured to store information about the system's workload and performance characteristics. For example, the configuration module 108 may store information about the types of I/O requests that are typically received, the frequency of I/O requests, and the average response time of the system. The configuration module 108 may also store information about the system's performance characteristics, such as the throughput and latency of I/O operations. This information is used by tier management module 102 and routing module 106 to optimize the system's performance and efficiency. The configuration module 108 may be updated dynamically as the system's workload and performance characteristics change. The configuration module 108 may also be used to store and manage other types of configuration information, such as security settings and logging information.

In an embodiment, application A 110 is an application that makes I/O requests to dispatcher 100. Application A 110 may be a database application, a file system, or a network application. Application A 110 is configured to make I/O requests to dispatcher 100 with a tier designation. The tier designation indicates the level of service for the I/O operation, such as low-latency or high-throughput. Application A 110 may be configured to use different tiers for different types of I/O operations. For example, application A 110 may use a low-latency tier for critical I/O operations and a high-throughput tier for non-critical I/O operations.

In an embodiment, application B 120 is another application that makes I/O requests to dispatcher 100. Like application A 110, application B 120 may be a database application, a file system, or a network application. Application B 120 is also configured to make I/O requests to dispatcher 100 with a tier designation. Dispatcher 100 uses the tier designation to determine the optimal execution path for the I/O operation. Application B 120 may be configured to use different tiers for different types of I/O operations, and dispatcher 100 may prioritize I/O operations from application B 120 based on their tier designation. Application B 120 may have different I/O requirements than application A 110, and dispatcher 100 may be configured to support both applications with different I/O requirements. Application B 120 may be running on the same or a different system than application A 110. Dispatcher 100 may be configured to support multiple applications with different I/O requirements, and both applications A 110 and B 120 may be supported by dispatcher 100.

In an embodiment, kernel 130 is a kernel that manages the system's hardware resources and provides services to applications. Kernel 130 may be a Linux kernel, but it could also be another type of kernel, such as a Windows kernel or a Unix kernel. Kernel 130 is responsible for managing the system's hardware resources, including the CPU, memory, and I/O devices. Kernel 130 provides a layer of abstraction between the applications and the hardware, allowing applications to access the hardware resources without needing to know the details of the hardware.

In an embodiment, kernel 130 is configured to manage I/O operations between the applications and the devices. Kernel 130 receives I/O requests from dispatcher 100 and submits them to the devices for processing. Kernel 130 is responsible for managing the submission queue 140 and completion queue 150 that store I/O requests and their results, respectively. Kernel 130 may use various scheduling algorithms to prioritize I/O operations and allocate resources. Kernel 130 may also provide different services, such as device management, interrupt handling, and memory management.

In an embodiment, kernel 130 provides an interface for dispatcher 100 to interact with the kernel. Dispatcher 100 may use this interface to submit I/O requests to the kernel and retrieve the results of I/O operations. Kernel 130 may provide a set of APIs or system calls that dispatcher 100 can use to interact with the kernel. Kernel 130 may also provide a set of data structures, such as the submission queue 140 and completion queue 150, that dispatcher 100 can use to manage I/O operations. The kernel 130 may be configured to support different types of devices, such as block devices, character devices, or network devices.

In an embodiment, kernel 130 is a component of the system that manages the system's hardware resources and provides services to applications. The kernel 130 may be optimized for performance, power consumption, or other criteria. The kernel 130 may be configured to support different types of applications, such as real-time applications or high-performance applications. The kernel 130 may also be configured to support different types of devices, such as storage devices or network devices. The kernel 130 interacts with dispatcher 100 to manage I/O operations and provide services to applications. The kernel 130 may be a Linux kernel, but other kernels may also be used. The kernel 130 provides a layer of abstraction between the applications and the hardware, allowing applications to access the hardware resources without needing to know the details of the hardware.

In an embodiment, submission queue 140 is a data structure that stores I/O requests submitted by dispatcher 100. Submission queue 140 is used by kernel 130 to manage I/O requests and submit them to the devices for processing. The submission queue 140 may be implemented as a ring buffer or other data structure that allows for efficient insertion and removal of I/O requests. In an embodiment, submission queue 140 is used with io_uring, a Linux kernel feature that provides an efficient and scalable way to submit and manage I/O requests. io_uring allows applications to submit I/O requests to the kernel in a batch, reducing the overhead of individual I/O requests.

In an embodiment, io_uring is used to implement submission queue 140. io_uring provides a shared memory region that allows applications to submit I/O requests to the kernel. The shared memory region is divided into a submission queue and a completion queue. The submission queue is used to store I/O requests, while the completion queue is used to store the results of I/O operations. io_uring allows applications to submit I/O requests to the kernel in a batch, reducing the overhead of individual I/O requests. This approach improves the performance and efficiency of I/O operations.

In an embodiment, submission queue 140 is used to store I/O requests that are submitted by dispatcher 100. The I/O requests are stored in the submission queue 140 in a format that is compatible with io_uring. The kernel 130 retrieves the I/O requests from the submission queue 140 and submits them to the devices for processing. The kernel 130 may use various scheduling algorithms to prioritize I/O operations and allocate resources. The submission queue 140 may be implemented as a data structure that allows for efficient insertion and removal of I/O requests.

In an embodiment, submission queue 140 allows dispatcher 100 to submit I/O requests to kernel 130. The submission queue 140 may be used to support different types of I/O operations, such as read and write operations. The submission queue 140 may also be used to support different types of devices, such as block devices, character devices, or network devices. The submission queue 140 interacts with kernel 130 to manage I/O requests and provide services to applications. The submission queue 140 may be implemented as a ring buffer or other data structure that allows for efficient insertion and removal of I/O requests. The submission queue 140 may be used with io_uring to submit and manage I/O requests.

In an embodiment, completion queue 150 is a data structure that stores the results of I/O operations. Completion queue 150 is used by kernel 130 to notify dispatcher 100 of I/O completion. The completion queue 150 may be implemented as a ring buffer or other data structure that allows for efficient insertion and removal of I/O completion notifications. In an embodiment, completion queue 150 is used with io_uring.

In an embodiment, io_uring is used to implement completion queue 150. As previously discussed, io_uring provides a shared memory region that allows the kernel to store the results of I/O operations. The shared memory region is divided into a submission queue and a completion queue. The completion queue is used to store the results of I/O operations, while the submission queue is used to store I/O requests. io_uring allows the kernel to store the results of I/O operations in the completion queue 150, and dispatcher 100 can retrieve the results from the completion queue 150.

In an embodiment, completion queue 150 is used to store the results of I/O operations that are submitted by dispatcher 100. The results of I/O operations are stored in the completion queue 150 in a format that is compatible with io_uring. Dispatcher 100 retrieves the results of I/O operations from the completion queue 150 and uses them to inform future I/O requests. The completion queue 150 may be implemented as a data structure that allows for efficient insertion and removal of I/O completion notifications.

In an embodiment, completion queue 150 is a component of the system that allows kernel 130 to notify dispatcher 100 of I/O completion. The completion queue 150 may be used to support different types of I/O operations, such as read and write operations. The completion queue 150 may also be used to support different types of devices, such as block devices, character devices, or network devices. The completion queue 150 interacts with kernel 130 to manage I/O operations and provide services to applications. The completion queue 150 may be implemented as a ring buffer or other data structure that allows for efficient insertion and removal of I/O completion notifications. The completion queue 150 may be used with io_uring to manage I/O completion.

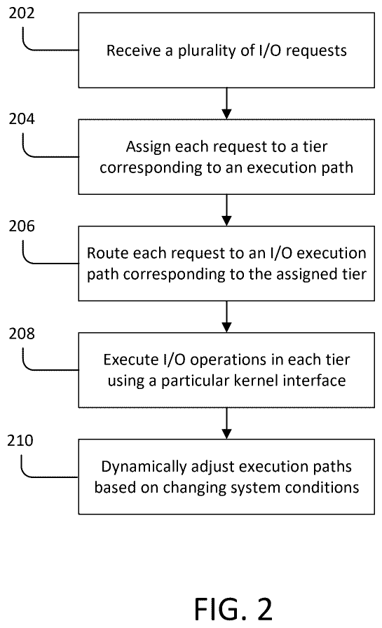

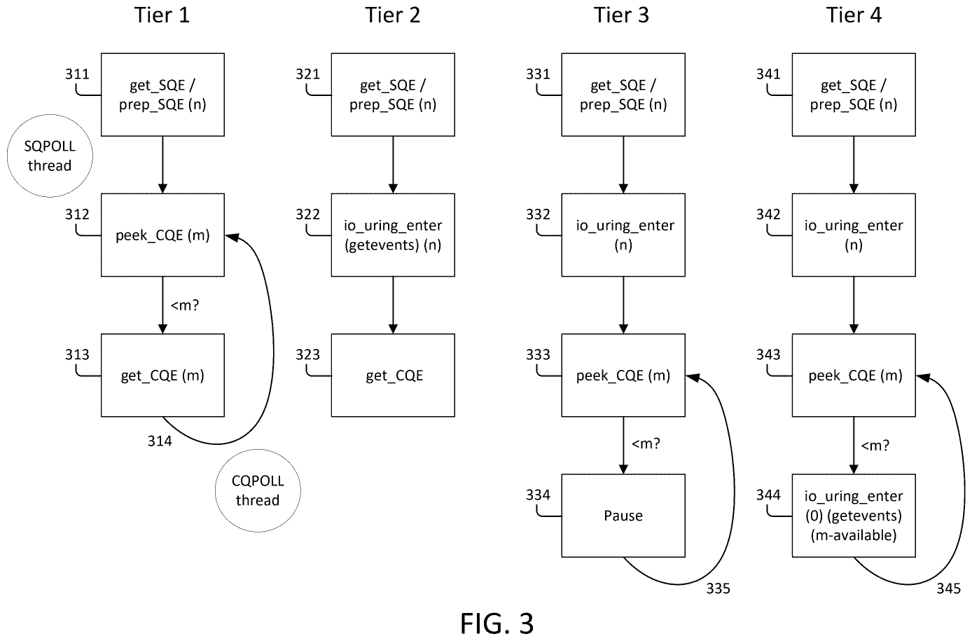

In one or more embodiments, a system refers to hardware and/or software configured to perform operations described herein for I/O management. Examples of operations for I/O management are described below with reference to FIGS. 2 and 3.

In an embodiment, the system is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Efficient I/O Management

FIG. 2 illustrates an example set of operations for efficiently managing I/O in a system in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system receives a plurality of I/O requests (Operation 202). These requests may be generated by applications, such as database systems, file systems, or network systems. The I/O requests may be of different types, such as read or write requests, and may have different requirements, such as latency or throughput requirements. The system may receive I/O requests from multiple sources, such as applications or other systems. The I/O requests may be received through a variety of interfaces, such as APIs or system calls.

In an embodiment, the system processes the I/O requests to determine the optimal execution path for the requests. The system may use various techniques to analyze the I/O requests and determine the optimal execution path. The system may consider various factors, such as the type of I/O request, the priority of the request, and the current system load. The system may also consider the requirements of the application that generated the I/O request, such as latency or throughput requirements. The system may use this information to determine the optimal execution path for an I/O request that supports the requirements of the application. The system may also use historical data, such as past performance characteristics, to inform its decisions. The system may be configured to handle a large number of I/O requests, and the system may be designed to scale to meet the needs of large and complex systems. The system may also be configured to handle different types of I/O requests, such as synchronous or asynchronous requests. The system may use a variety of data structures, such as queues or buffers, to manage the I/O requests and optimize their execution.

In an embodiment, the system assigns requests to a tier corresponding to an execution path (Operation 204). The system may use various techniques to assign I/O requests to tiers, such as analyzing the I/O request and determining the optimal tier based on predefined criteria. The system may consider factors, such as the type of I/O request, the priority of the request, and the current system load, when assigning I/O requests to tiers. The system may also consider the requirements of the application that generated the I/O request. The system assigns an I/O request to a tier that corresponds to an execution path that supports the requirements of the application.

In an embodiment, the system may assign I/O requests to tiers based on a variety of factors, including the size of the request, the type of data being transferred, and the deadline for completion. The system may also consider the current system load and the availability of resources when assigning I/O requests to tiers. The system may use a variety of data structures, such as queues or buffers, to manage the I/O requests and optimize their execution. The system may also use historical data, such as past performance characteristics, to inform its decisions about assigning I/O requests to tiers. The system may be configured to handle a large number of I/O requests, and the system may be designed to scale to meet the needs of large and complex systems.

In an embodiment, the system may use a tier management module to assign I/O requests to tiers. The tier management module may be configured to analyze I/O requests and determine the optimal tier for requests. The tier management module may use a variety of techniques, such as analyzing I/O requests, determining the optimal tier, and routing the requests to the corresponding execution path. The system may also use configuration information, such as system resource utilization and I/O priority, to determine the optimal tier for requests. The system may dynamically adjust the tier assignment based on changing system conditions, such as changes in system resource utilization or I/O priority. The system may also use feedback mechanisms to adjust the tier assignment based on the performance of the I/O operations. The system may assign I/O requests to tiers based on multiple criteria, and the system may use a combination of these criteria to determine the optimal tier for a request.

In an embodiment, the system routes a request to an I/O execution path corresponding to the assigned tier (Operation 206). The execution path may involve using io_uring, a kernel interface that provides a ring buffer for submitting and completing I/O requests. The system may use get_SQE (get submission queue entry) to obtain a submission queue entry and prep_SQE (prepare submission queue entry) to prepare the submission queue entry for I/O operations. The system may then use io_uring_enter to submit the I/O request to the kernel. The io_uring_enter interface may be used with various flags, such as ALL_SQ (all submission queue), getevents, or 0 (no flags), to control the behavior of the I/O operation.

In an embodiment, the use of io_uring_enter with different flags can result in different outcomes. For example, using io_uring_enter with getevents may cause the system to wait for the completion of the I/O operation, whereas using io_uring_enter with 0 may allow the system to continue executing other tasks without waiting for completion. The system may also use peek_CQE (peek completion queue entry) to check the completion queue for completed I/O operations. The ordering of these operations can result in different trade-offs, such as CPU usage, threads, blocking, speed, etc.

In an embodiment, the system may employ an execution path that uses SQPOLL (submission queue poll) and CQPOLL (completion queue poll) to submit and complete I/O operations. This approach may provide low-latency I/O operations but may also use more CPU resources. For another execution path, the system may use io_uring_enter with getevents to submit and complete I/O operations that may provide a blocking I/O operation. This approach may be simpler to implement but may also result in higher latency.

In an embodiment that uses a different execution path, the system may use CQPOLL to complete I/O operations, whereas for a different execution path, the system may use a lazy reaping approach, where the system periodically checks the completion queue for completed I/O operations using peek_CQE. The lazy reaping approach may provide a good balance between CPU usage and latency. The system may dynamically adjust the execution path based on changing system conditions, such as changes in system resource utilization or I/O priority.

In an embodiment, the system may use a combination of these approaches to optimize I/O operations. For example, the system may use SQPOLL and CQPOLL for low-latency I/O operations and use lazy reaping for high-throughput I/O operations. The system may also use feedback mechanisms to adjust the execution path based on the performance of the I/O operations. The system may assign I/O requests to tiers based on a variety of factors, including the type of I/O operation, the priority of the request, and the current system load. The system may use a tier management module to manage the execution paths and may use a configuration module to store and manage configuration information.

In an embodiment, the system executes I/O operations in different tiers using a particular kernel interface (Operation 208). The kernel interface may be an asynchronous I/O interface that comprises a ring buffer used for submitting and completing I/O requests. The ring buffer may be implemented using a data structure, such as a circular buffer or a queue. The kernel interface may provide a set of APIs or system calls that allow the system to submit I/O requests and retrieve the results of I/O operations.

In an embodiment, the system may use the kernel interface to submit I/O requests to the device and retrieve the results of I/O operations. The kernel interface may be configured to support different types of I/O operations, such as read, write, or scatter-gather operations. The system may use the kernel interface to execute I/O operations in a non-blocking manner, allowing the system to continue executing other tasks while waiting for the I/O operations to complete.

In an embodiment, the kernel interface may be implemented using io_uring, a Linux kernel feature that may be used to submit and complete I/O requests. The system may use the get_SQE (get submission queue entry) command to obtain a submission queue entry and the prep_SQE (prepare submission queue entry) command to prepare the submission queue entry for I/O operations. The system may then use io_uring_enter to submit the I/O request to the kernel. The io_uring_enter interface may be used with various flags, such as the ALL_SQ (all submission queue) flag, the getevents flag, or 0 (no flags), to control the behavior of the I/O operation.

In an embodiment, the system may use the peek_CQE command to check the completion queue for completed I/O operations. The system may use io_uring_enter with the getevents flag to wait for the completion of I/O operations or with 0 (representing no flags) to allow the system to continue executing other tasks without waiting for completion. The system may dynamically adjust the use of these interfaces based on changing system conditions, such as changes in system resource utilization or I/O priority.

In an embodiment, the system may use a combination of these interfaces to optimize I/O operations. For example, the system may use io_uring_enter with the getevents flag for I/O operations that require low-latency and with 0 (no flags) for I/O operations that can tolerate higher latency. The system may also use feedback mechanisms to adjust the use of these interfaces based on the performance of the I/O operations. The system may use a tier management module to manage the execution paths, and the system may use a configuration module to store and manage configuration information.

In an embodiment, the system may be configured to handle a large number of I/O requests, and the system may be designed to scale to meet the needs of large and complex systems. The system may also be configured to handle different types of I/O requests, such as synchronous or asynchronous requests. The system may use a variety of data structures, such as queues or buffers, to manage I/O requests and optimize their execution. The system may also use various techniques, such as batching, caching, and prioritizing I/O requests, to optimize I/O operations.

In an embodiment, the system dynamically adjusts execution paths based on changing system conditions (Operation 210). The system may monitor system resources, such as CPU usage, memory usage, and I/O bandwidth, to determine when to adjust the execution paths. For example, if the system detects that CPU usage is high, it may switch to a different execution path that uses fewer CPU resources. The system may also adjust the execution paths based on changes in I/O priority such as when a high-priority I/O request is received. The system may use a fairness algorithm to ensure that not all requests can be considered priority requests unless system resources are operating at less than a certain threshold such as 80% usage.

In an embodiment, the system may use a fairness algorithm to distribute I/O requests across different tiers based on system resource utilization. For example, if system resources are at a certain threshold, such as 80% usage, the system may limit the number of I/O requests that can be assigned to a high-priority tier such as Tier 1. The system may assign a maximum of 50% of requests to Tier 1, 30% to Tier 2, and 20% to Tier 3. The system may use historical data, such as logs of previously executed I/O operations, to determine the requests that may not be hurt by the tier shift. For example, the system may know that I/O requests of a certain type, such as read operations, can be safely reassigned to a lower-priority tier without impacting performance.

In an embodiment, the system may adjust execution paths based on changes in I/O workload. For example, if the system detects a sudden increase in I/O requests, it may adjust the execution paths to prioritize requests based on their urgency and importance. The system may use a variety of techniques, such as machine learning (ML) algorithms or predictive modeling, to anticipate changes in I/O workload and adjust the execution paths proactively. The system may also use feedback mechanisms to adjust the execution paths based on the performance of the I/O operations. For example, if the system detects that a particular execution path is resulting in high latency or low throughput, the system may adjust the execution path to optimize performance.

In an embodiment, the system may use a tier management module to manage the execution paths and adjust the paths based on changing system conditions. The tier management module may be configured to analyze I/O requests and determine the optimal execution path for requests. The tier management module may use a variety of data structures, such as queues or buffers, to manage I/O requests and optimize their execution. The system may also use a configuration module to store and manage configuration information, such as the number of I/O requests to allow for each tier, the priority of I/O requests, and the deadline for completion.

In an embodiment, the system may dynamically adjust execution paths based on changes in system resource utilization or I/O priority. For example, if the system detects that CPU usage is high and I/O priority is low, the system may adjust the execution paths to prioritize I/O requests based on their urgency and importance. The system may use a variety of techniques, such as scheduling algorithms or resource allocation, to optimize the execution paths and ensure that I/O operations are completed efficiently. The system may also use historical data, such as logs of previously executed I/O operations, to inform its decisions about adjusting the execution paths. The system may adjust the execution paths in real time, or the system may use a more proactive approach to anticipate changes in system conditions, adjusting the execution paths accordingly.

In an embodiment, one execution path includes a polling operation, whereas another different execution path does not include a polling operation. For example, a system may use a polling-based execution path for I/O operations that require low-latency, such as log writes or transaction commits. In this execution path, the system may use a command, such as peek_CQE, to periodically check the completion queue for completed I/O operations. In contrast, another execution path may not use polling, instead relying on a callback or interrupt-based approach to notify the system of I/O completion. This approach may be used for I/O operations that can tolerate higher latency, such as background tasks or large data transfers.

In an embodiment, the system may dynamically switch between polling and non-polling execution paths based on changing system conditions. For example, if the system detects that CPU usage is high, the system may switch to a non-polling execution path to reduce CPU utilization. Conversely, if the system detects that I/O latency is high, the system may switch to a polling-based execution path to improve responsiveness. The system may use a tier management module to manage the execution paths and make decisions about when to switch between polling and non-polling execution paths. The tier management module may use a variety of data structures, such as queues or buffers, to manage I/O requests and optimize their execution. The system may also use historical data, such as logs of previously executed I/O operations, to inform its decisions about an execution path to use.

In an embodiment, assigning an I/O request to a tier may involve detecting an express or implied tier assignment identifier corresponding to an I/O request. For example, an application may indicate to the dispatcher that a particular tier is preferred using an explicit identifier associated with the tier, such as a numerical value or a string. The application may also indicate an I/O priority, such as high, medium, or low, that may correspond to a specific tier. Additionally, the application may describe its I/O requirements, such as latency or throughput requirements, that may also be used to determine the tier assignment.

In an embodiment, the system may use a variety of techniques to detect the tier assignment identifier. For example, the system may analyze the I/O request itself, such as by examining the request's priority or latency requirements. The system may also use external information, such as system resource utilization or I/O workload, to inform its tier assignment decisions. If an I/O tier is indicated, the system may assign the I/O request to a tier based at least in part on the tier assignment identifier corresponding to the request.

In an embodiment, the system may ignore tier requests based on system status and/or other environmental factors. For example, if system resources are heavily utilized, the system may not be able to accommodate all high-priority I/O requests. In this case, the system may assign I/O requests to tiers based on a fairness algorithm that ensures that not all requests can be considered priority requests. The system may use a variety of fairness algorithms, such as a weighted fair queuing algorithm or a rate monotonic scheduling algorithm, to allocate resources to I/O requests.

In an embodiment, the system may use historical data to inform its tier assignment decisions. For example, the system may maintain logs of previously executed I/O operations that may be used to determine the requests that may not be impacted by a tier shift. The system may analyze these logs to identify patterns or trends in I/O behavior and use this information to optimize its tier assignment decisions. The system may also use ML algorithms to predict the requests that are likely to be affected by a tier shift and adjust tier assignment decisions accordingly.

In an embodiment, the system may dynamically adjust tier assignment decisions based on changing system conditions. For example, if system resources are heavily utilized, the system may adjust tier assignment decisions to prioritize I/O requests based on their urgency and importance. The system may use a variety of techniques, such as scheduling algorithms or resource allocation, to optimize the execution of I/O requests. The system may also use feedback mechanisms to adjust its tier assignment decisions based on the performance of the I/O operations. For example, if the system detects that a particular tier is resulting in high latency or low throughput, it may adjust its tier assignment decisions to optimize performance.

In an embodiment, a tier assignment identifier is implied rather than explicit. For example, the tier assignment identifier may be a context associated with the request, such as a specific application or user, or with the state of the system, such as the current time of day or the system's workload. The system may use this implied tier assignment identifier to assign I/O requests to tiers without requiring explicit identification. For instance, the system may assign I/O requests from a specific application to a high-priority tier while assigning I/O requests from other applications to lower-priority tiers. The system may also use ML algorithms to infer the tier assignment identifier based on historical data.

In an embodiment, the system may assign an I/O request to a different tier than the requested tier. The system detects a tier assignment identifier corresponding to an I/O request and generates a tier assignment metric corresponding to a potential tier. The tier assignment metric indicates a quantity of I/O requests associated with the potential tier. Based at least in part on the tier assignment metric, the system assigns the I/O request to a different tier than the requested tier. For example, the assigned tier may be a higher or lower latency path than the requested tier. The system may use this approach to optimize I/O performance, for instance, by assigning I/O requests to tiers that have available resources or that are less congested. The system may also use feedback mechanisms to adjust tier assignment decisions based on the performance of the I/O operations.

In an embodiment, the system may reassign a less important request to make room for a more important request. This may occur when a high-priority I/O request is received and the system needs to free up resources to accommodate the request. The system may evaluate the importance of an I/O request based on various factors, such as the request's priority, deadline, or type. If a high-priority request is received, the system may reassign a less important request to a lower-priority tier, making room for the high-priority request. This may involve preempting an ongoing I/O operation or delaying a non-critical I/O request.

The system may use a variety of techniques to determine requests to reassign. For example, the system may use a scheduling algorithm, such as rate monotonic scheduling or earliest deadline first scheduling, to prioritize I/O requests. The system may also consider the impact of reassigning a request on the overall system performance and adjust decisions accordingly. Additionally, the system may use historical data, such as logs of previously executed I/O operations, to inform decisions about requests to reassign.

The system may reassign requests in real time or may use a more proactive approach to anticipate changes in system conditions and adjust decisions accordingly. For instance, if the system detects that a high-priority request is likely to be received soon, the system may proactively reassign less important requests to make room for the request. The system may also use feedback mechanisms to adjust decisions based on the performance of the I/O operations.

In an embodiment, the system may use a tier management module to manage the reassigning of requests. The tier management module may be configured to analyze I/O requests and determine requests to reassign. The tier management module may use a variety of data structures, such as queues or buffers, to manage I/O requests and optimize their execution. The system may also use a configuration module to store and manage configuration information, such as the number of I/O requests to allow for a tier, the priority of I/O requests, and the deadline for completion.

The system may reassign requests in a way that minimizes the impact on system performance. For example, the system may reassign requests that are not critical or that have a low priority. The system may also consider the type of I/O operation being performed, such as read or write operations, and reassign requests accordingly. By reassigning less important requests, the system can ensure that high-priority requests are processed efficiently and that system resources are utilized optimally.

In an embodiment, the kernel interface is associated with separate submission and completion queues. The submission queue is used to store I/O requests submitted by the system, while the completion queue is used to store the results of I/O operations. The kernel interface may be an asynchronous I/O interface, such as io_uring, used to submit and complete I/O requests. The use of separate submission and completion queues allows the system to manage I/O requests and their results efficiently. The submission queue may be implemented as a ring buffer that allows for efficient insertion and removal of I/O requests. The completion queue may also be implemented as a ring buffer that allows for efficient retrieval of I/O operation results.

In an embodiment, the kernel interface is an asynchronous I/O interface that comprises a ring buffer used for submitting and completing I/O requests and allows for non-blocking I/O operations. This kernel interface, such as io_uring, enables the system to submit multiple I/O requests concurrently and retrieve their results without blocking. The ring buffer is a data structure that allows for efficient insertion and removal of I/O requests and their results. The asynchronous nature of the interface allows the system to continue executing other tasks while waiting for I/O operations to complete, improving overall system performance and responsiveness. The kernel interface may also provide a set of APIs or system calls that allows the system to interact with the ring buffer and manage I/O operations. For example, the system may use the io_uring_enter system call to submit I/O requests and retrieve the results of I/O operations. The kernel interface may be highly configurable, allowing the system to optimize I/O performance for specific workloads or applications. By using an asynchronous I/O interface with a ring buffer, the system can efficiently manage I/O operations, improving overall performance. The kernel interface may also provide different features, such as batching, caching, and prioritization, that can further optimize I/O performance. Additionally, the kernel interface may be designed to work with different types of devices, such as storage devices or network devices, and may be highly scalable to support large and complex systems. The use of this kernel interface can help to improve the performance and efficiency of I/O operations and can be particularly useful in systems that require high-performance I/O, such as databases, file systems, and cloud computing platforms. In an embodiment, the system assigns requests to tiers based on latency targets corresponding to the request being assigned.

In an embodiment, the system can assign requests to tiers based on service level requirements that correspond to the request being assigned. Service level requirements, such as latency, throughput, and priority, may be used in determining the tier assignment for an I/O request. The system may use a service level agreement (SLA) or service level objective (SLO) to guide its tier assignment decisions. For example, an I/O request with a low-latency SLA may be assigned to a high-priority tier, whereas an I/O request with a high-throughput SLO may be assigned to a lower-priority tier.

In an embodiment, the system may also consider other factors, such as the type of I/O operation, the size of the request, and the current system load, when assigning requests to tiers based on service level requirements. Considering SLAs or SLOs may specify requirements for I/O operations, such as response time, throughput, and error rates. The system may use these requirements to determine a tier to assign I/O requests to and ensure that I/O operations are executed in a way that meets the specified requirements. By assigning I/O requests to tiers based on service level requirements, the system can ensure that I/O operations are executed efficiently and effectively, and the needs of different applications and users are met. The system may also use service level requirements to prioritize I/O requests and allocate resources accordingly. For example, I/O requests with high-priority service level requirements may be assigned to a higher-priority tier, whereas I/O requests with lower-priority service level requirements may be assigned to a lower-priority tier. By considering service level requirements, the system can ensure that I/O operations are executed in a way that meets the needs of different applications and users, and system resources are utilized efficiently.

In an embodiment, the system considers the size of the request being assigned. The size of a request can be a factor in determining a tier to assign the request to. For example, large requests may require more resources and may be better suited to a tier with more available resources. Conversely, small requests may be able to be handled by a tier with fewer resources. The system may use a variety of techniques to determine the optimal tier for a request based on its size. For example, the system may use a threshold-based approach where requests above a certain size are assigned to a higher-priority tier. The system may also use a more sophisticated algorithm, such as an ML model, to determine the optimal tier for a request based on its size and other factors. By considering the size of requests, the system can optimize performance and ensure that requests are handled efficiently. The system may also consider other factors, such as the type of request, the priority of the request, and the current system load, when assigning requests to tiers. For example, a large request with a high priority may be assigned to a higher-priority tier, whereas a small request with a low priority may be assigned to a lower-priority tier. By considering multiple factors, the system can make informed decisions about a tier to assign requests to, and can optimize its performance accordingly. The system may also dynamically adjust tier assignment decisions based on changing system conditions, such as changes in system resource utilization or I/O workload. For instance, if the system detects that a high-priority request is likely to be received soon, the system may proactively reassign requests to make room for the request. The system may also use feedback mechanisms to adjust tier assignment decisions based on the performance of the I/O operations. For example, if the system detects that a particular tier is resulting in high latency or low throughput, the system may adjust tier assignment decisions to optimize performance. By dynamically adjusting tier assignment decisions, the system can ensure that I/O operations are executed efficiently and effectively, and the needs of different applications and users are met. The system may also use a combination of these techniques to optimize performance and ensure that requests are handled efficiently.

In an embodiment, access patterns corresponding to requests similar to the request being assigned are used by the system to assign requests to tiers. The system may analyze the access patterns of similar requests to determine the optimal tier for a given request. For example, if a request is part of a sequential access pattern, the request may be assigned to a tier optimized for sequential I/O operations. Conversely, if a request is part of a random access pattern, the request may be assigned to a tier optimized for random I/O operations. The system may use various techniques to analyze access patterns, such as tracking the frequency and timing of requests, to inform tier assignment decisions. By taking into account access patterns, the system can optimize performance and ensure that requests are handled efficiently. The system may also consider other factors, such as the type of request, the priority of the request, and the current system load, when assigning requests to tiers. For example, a request with a high priority may be assigned to a higher-priority tier, whereas a request with a low priority may be assigned to a lower-priority tier.

In an embodiment, the system may dynamically adjust tier assignment decisions based on changing system conditions, such as changes in system resource utilization or I/O workload. The system may use feedback mechanisms to adjust tier assignment decisions based on the performance of the I/O operations. By analyzing access patterns and adjusting tier assignment decisions accordingly, the system can ensure that I/O operations are executed efficiently and effectively, and the needs of different applications and users are met. The system may also use historical data, such as logs of previously executed I/O operations, to inform tier assignment decisions. The system may use ML algorithms to predict a tier that is likely to provide the best performance for a given request based on access patterns and other factors. The system may also use a combination of these techniques to optimize performance and ensure that requests are handled efficiently. The system may assign requests to tiers based on access patterns, and the system may also consider other factors, such as request size, request priority, and system load. By considering multiple factors, the system can make informed decisions about a tier to assign requests to and can optimize performance accordingly.

In an embodiment, the system assigns requests to tiers based on historical performance characteristics corresponding to requests similar to the request being assigned. The system may analyze historical data, such as logs of previously executed I/O operations, to determine the performance characteristics of similar requests. For example, the system may track the response time, throughput, and error rate of similar requests to determine a tier that is likely to provide the best performance for a given request. The system may use this historical data to inform its tier assignment decisions, assigning requests to tiers that have historically provided good performance for similar requests. The system may also consider other factors, such as the type of request, the priority of the request, and the current system load, when assigning requests to tiers. By taking into account historical performance characteristics, the system can optimize performance and ensure that requests are handled efficiently.

In an embodiment, the system may dynamically adjust tier assignment decisions based on changing system conditions, such as changes in system resource utilization or I/O workload. The system may use feedback mechanisms to adjust tier assignment decisions based on the performance of the I/O operations. By analyzing historical performance characteristics and adjusting tier assignment decisions accordingly, the system can ensure that I/O operations are executed efficiently and effectively, and the needs of different applications and users are met. The system may also use ML algorithms to predict a tier likely to provide the best performance for a given request based on historical performance characteristics and other factors. The system may assign requests to tiers based on historical performance characteristics, and the system may also consider other factors, such as request size, request priority, and system load. By considering multiple factors, the system can make informed decisions about a tier to assign requests to and can optimize performance accordingly.

In an embodiment, the system may use a combination of these techniques to optimize performance and ensure that requests are handled efficiently. The historical data may be collected over a period of time, and the data may be updated periodically to reflect changes in system performance. In addition to historical data, the system may also use real-time data to inform tier assignment decisions. The system may be configured to handle a large number of requests, and the system may be designed to scale to meet the needs of large and complex systems.

In an embodiment, the system assigns requests to tiers based at least in part on a classification corresponding to the request being assigned. The system may classify requests into different categories, such as read or write requests, sequential or random requests, or requests with different priority levels. Based on the classification, the system may assign the request to a tier that is optimized for that type of request. For example, read requests may be assigned to a tier with a high read throughput, whereas write requests may be assigned to a tier with a high write throughput. The system may use a variety of techniques to classify requests, such as analyzing the request's opcode, data size, or other attributes. The system may also use ML algorithms to classify requests based on their characteristics and assign requests to the optimal tier. By classifying requests and assigning the requests to tiers based on their characteristics, the system can optimize performance and ensure that requests are handled efficiently. The system may dynamically adjust tier assignment decisions based on changing system conditions, such as changes in system resource utilization or I/O workload. The system may use feedback mechanisms to adjust tier assignment decisions based on the performance of the I/O operations. By analyzing request classifications and adjusting tier assignment decisions accordingly, the system can ensure that I/O operations are executed efficiently and effectively, and the needs of different applications and users are met. The system may also use historical data, such as logs of previously executed I/O operations, to inform tier assignment decisions. The system may assign requests to tiers based on a combination of factors, including request classification, request size, request priority, and system load. By considering multiple factors, the system can make informed decisions about a tier to assign requests to and can optimize performance accordingly. The system may use a tier management module to manage the assignment of requests to tiers, and the system may use a configuration module to store and manage configuration information. The system may be configured to handle a large number of requests, and the system may be designed to scale to meet the needs of large and complex systems. The system may also be designed to work with different types of devices, such as storage devices or network devices. The system may use a variety of data structures, such as queues or buffers, to manage requests and optimize their execution. The system may also use various techniques, such as batching, caching, and prioritizing requests, to optimize performance.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims. FIG. 3 illustrates an example set of operations for efficiently managing I/O in a system in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

In an embodiment, the system assigns one or more I/O requests to Tier 1. The system uses the get_SQE command to obtain one or more submission queue entries and the prep_SQE command to prepare the submission queue entries for I/O operations (Operation 311). The system uses the get_SQE command to retrieve a submission queue entry (SQE) from a shared memory region. The SQE is a data structure that comprises information about the I/O request, such as the file descriptor, offset, and data address. The system then uses the prep_SQE command to prepare the SQE for I/O operations, setting up the SQE with the necessary information to execute the I/O request. The system may repeat this process to obtain and prepare multiple SQEs for I/O operations. After preparing the SQEs, a kernel polling thread (SQPOLL) can submit the I/O requests to the kernel and check for available I/O requests in a loop. The SQPOLL thread can submit the I/O requests without needing to call io_uring_enter to notify the kernel of available I/O requests.

In an embodiment, the system uses the peek_CQE command to check the completion queue for completed I/O operations (Operation 312). The system uses the peek_CQE command to retrieve a completion queue entry (CQE) from the completion queue without removing it. The CQE is a data structure that comprises information about the completed I/O operation, such as the result code and user data. The system may use the peek_CQE command to check if any I/O operations have completed, and if so, to retrieve the CQE. The system checks to see if it has received at least m results to ensure that it has enough completed I/O operations to process. If the number of completed I/O operations is less than m, the system may need to wait for additional I/O operations to complete.

In an embodiment, the system uses the get_CQE command to retrieve the results of completed I/O operations (Operation 313). The system invokes the get_CQE command to read a completion-queue entry from a memory-mapped ring buffer that the kernel populates as I/O operations finish. The implementation first snapshots the CQ tail index published by the producer and compares it to the consumer's head index to determine availability without touching any unrelated state. When an entry is available, get_CQE reads the CQE and exposes its key fields.

In an embodiment, the user polling thread, CQPOLL loops and checks the results from CQE (Operation 314). This loop allows the system to continue checking the completion queue for completed I/O operations and waiting for completion of available requests until the system has received the desired number of results. The system may repeat operations 312 and 313 until the system has received the desired number of results, and the system may then proceed with processing the completed I/O operations.

In an embodiment, Tier 1 is useful for critical I/O operations that require low-latency and high IOPS (Input/Output Operations Per Second) with minimal jitter. For example, in a financial trading platform, Tier 1 can be used for I/O operations related to trade execution, such as writing to a log file or updating a database. These operations require fast and predictable performance to ensure that trades are executed quickly and accurately. By using Tier 1, the platform can ensure that these I/O operations are handled efficiently and with minimal delay. Tier 1 provides low-latency and high IOPS with minimal jitter, but may use more CPU resources due to the use of SQPOLL and CQPOLL. This tier is optimized for I/O operations that require fast and predictable performance.

In an embodiment, the system assigns one or more I/O requests to Tier 2. The system uses the get_SQE command to obtain one or more submission queue entries and the prep_SQE command to prepare the submission queue entries for I/O operations (Operation 321).

In an embodiment, the system uses the io_uring_enter command with the getevents flag to wait for completion of I/O operations (Operation 322). The getevents flag indicates that the system should wait for completion of I/O operations and retrieve the results of completed I/O operations. The system may wait for a specified amount of time or until a certain condition is met such as the completion of a certain number of requests. Once the system has received the results of the I/O operations, the system may proceed with processing the completed I/O operations.

In an embodiment, the system uses the get_CQE command to retrieve the results of completed I/O operations (Operation 323). The system uses the get_CQE command to retrieve a CQE from the completion queue. The CQE is a data structure that comprises information about the completed I/O operation, such as the result code and user data. The system may use the get_CQE command to retrieve the CQE and process the results of the I/O operations. The system may repeat this process to retrieve multiple CQEs and process the results of multiple I/O operations.

In an embodiment, Tier 2 represents blocking I/O without polling and is useful for moderate-latency I/O operations that do not require low-latency or high IOPS. For example, in a file server, Tier 2 can be used for I/O operations related to reading or writing files. These operations can tolerate some latency and do not require the high level of performance provided by Tier 1. By using Tier 2, the file server can handle I/O operations efficiently and effectively without incurring the overhead of more complex I/O management strategies. Tier 2 provides moderate latency and IOPS but may block the issuing thread until completion of the I/O operation. This tier is suitable for I/O operations that can tolerate some latency and do not require low-latency or high IOPS.

In an embodiment, the system assigns one or more I/O requests to Tier 3. The system uses the get_SQE command to obtain one or more submission queue entries and uses the prep_SQE command to prepare the submission queue entries for I/O operations (Operation 331).

In an embodiment, the system uses the io_uring_enter command to submit the I/O requests to the kernel (Operation 332). The io_uring_enter command allows the system to submit multiple I/O requests to the kernel and then continue executing other tasks.

In an embodiment, the system uses the peek_CQE command to check the completion queue for completed I/O operations (Operation 333). The system uses the peek_CQE command to retrieve a CQE from the completion queue without removing it. The CQE is a data structure that comprises information about the completed I/O operation, such as the result code and user data. The system checks to see if the system has received at least m results to ensure that it has enough completed I/O operations to process. If the number of completed I/O operations is less than m, the system may need to wait for additional I/O operations to complete.

In an embodiment, the system pauses (Operation 334) to allow other tasks to execute or to wait for additional I/O operations to complete. The pause may be implemented using a variety of techniques, such as a busy-wait loop or a sleep operation.

The system loops back to operation 333 after the pause to continue checking the completion queue for completed I/O operations (Operation 335). The system may repeat this process until it has received at least m results, and the system may proceed with processing the completed I/O operations. The loop allows the system to efficiently handle I/O operations and ensure that the operations are completed in a timely manner.

In an embodiment, Tier 3 represents I/O with completion polling and is useful for I/O operations that benefit from deferred submission but require guaranteed completion. For example, in a database system, Tier 3 can be used for I/O operations related to writing data to disk. These operations require guaranteed completion to ensure data consistency and integrity. By using Tier 3, the database system can separate the submission and completion of I/O operations, reducing blocking costs and allowing for higher batching of completions. Tier 3 provides a balance between latency and IOPS with some latency due to the use of CQPOLL or batch polling. This tier separates submission and completion responsibilities, reducing blocking costs and allowing for higher batching of completions.

In an embodiment, the system assigns one or more I/O requests to Tier 4. The system uses the get_SQE command to obtain one or more submission queue entries and uses the prep_SQE command to prepare the submission queue entries for I/O operations (Operation 341).

In an embodiment, the system uses the io_uring_enter command to submit the I/O requests to the kernel (Operation 342). The io_uring_enter command allows the system to submit multiple I/O requests to the kernel and then continue executing other tasks.

In an embodiment, the system uses the peek_CQE command to check the completion queue for completed I/O operations (Operation 343). The system uses the peek_CQE command to retrieve a CQE from the completion queue without removing it. The CQE is a data structure that comprises information about the completed I/O operation, such as the result code and user data. The system checks to see if it has received at least m results to ensure that it has enough completed I/O operations to process. If the number of completed I/O operations is less than m, the system may need to wait for additional I/O operations to complete.

In an embodiment, the system uses the io_uring_enter command with a flag value of 0 and the getevents flag to wait for completion of available requests (Operation 344). The system retrieves the results of completed I/O operations. The flag value of 0 indicates that the system should not submit new requests; instead, the system should wait for completion of existing requests. The getevents flag indicates that the system should retrieve the results of completed I/O operations. The system may wait for a specified amount of time or until a certain condition is met such as the completion of a certain number of requests. Once the system has received the results of the I/O operations, the system may proceed with processing the completed I/O operations. Operation 344 in Tier 4 uses a flag value of 0 to wait for completion of available requests without submitting new requests. This approach allows the system to lazily reap completed I/O operations that can help to improve performance and efficiency.

In an embodiment, the system loops back to operation 343 (peek_CQE (m)) to continue checking the completion queue for completed I/O operations (Operation 345). The system may repeat this process until it has received the desired number of results, and the system may proceed with processing the completed I/O operations.

In an embodiment, Tier 4 represents fully asynchronous I/O without polling and is useful for high-volume, latency tolerant I/O streams like background tasks. For example, in a cloud storage system, Tier 4 can be used for I/O operations related to archiving data. These operations can tolerate high latency and do not require a high level of performance provided by other tiers. By using Tier 4, the cloud storage system can maximize throughput by batching both submission and completion, making it suitable for high-volume I/O streams. Tier 4 provides high throughput and IOP but may have higher latency due to the lazy reaping of completed I/O operations. This tier is suitable for high-volume, latency tolerant I/O streams, like background tasks, and maximizes throughput by batching both submission and completion.

### 5. Practical Applications, Advantages, and Improvements

Embodiments of the present disclosure provide several practical applications, advantages, and improvements over existing approaches to I/O management. For example, in the context of database systems, embodiments improve upon existing approaches by reducing latency and increasing throughput, resulting in improved performance and increased user satisfaction. This is accomplished by using a tiered I/O management system that allows for efficient handling of I/O operations with different latency and throughput requirements.

In an embodiment, the tiered I/O management system enables efficient handling of critical I/O operations, such as redo log writes and transaction commits, by using a dedicated dispatcher process running in SQPOLL+CQPOLL mode. This improvement provides a technical benefit by reducing latency and increasing throughput, and this improvement provides an economic benefit by improving the overall performance and efficiency of the system. For instance, in a financial trading platform, the use of this tiered I/O management system can enable faster and more reliable trade execution, resulting in improved user satisfaction and increased revenue.

Embodiments implementing the tiered I/O management system, as described herein, enable efficient handling of I/O operations with different latency and throughput requirements. This is accomplished by using a combination of SQPOLL, CQPOLL, and lazy reaping of completed I/O operations. For example, in a cloud storage system, the use of this tiered I/O management system can enable efficient handling of I/O operations related to archiving data, resulting in improved performance and increased scalability.

By providing a tiered I/O management system, embodiments address a specific problem or need in the technical field of I/O management. This results in improved performance, increased user satisfaction, and reduced costs. Embodiments improve upon existing approaches by reducing latency and increasing throughput, resulting in improved performance and increased user satisfaction.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

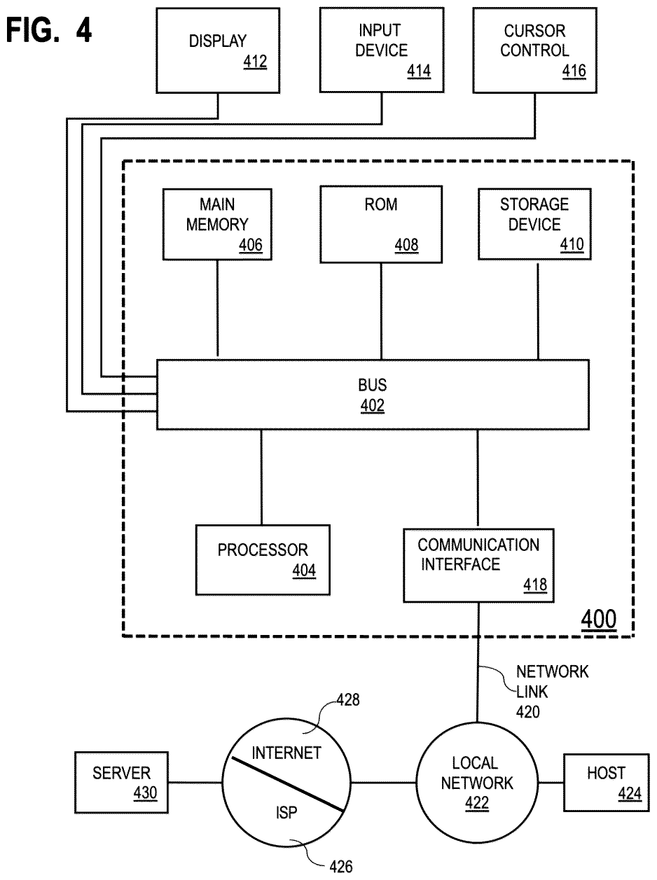

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read-only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method for managing input/output (I/O) operations in a computing system, comprising:
receiving, at an intermediary for dispatching I/O requests, a plurality of I/O requests;
assigning each request of the plurality of I/O requests to a tier of a plurality of tiers, wherein each tier of the plurality of tiers is associated with a corresponding execution path that includes a same particular kernel interface;
routing each I/O request of the plurality of requests to an I/O execution path corresponding to its assigned tier;
executing I/O operations in each tier in the plurality of tiers using at least the particular kernel interface; and
wherein the method is performed by at least one device including a hardware processor.

2. The method of claim 1, further comprising:
dynamically adjusting one or more execution paths based at least in part on changing system conditions or workload characteristics.

3. The method of claim 1, wherein a first execution path includes a polling operation and a second execution path does not include a polling operation.

4. The method of claim 1, wherein assigning each I/O request to a tier further comprises:
detecting a tier assignment identifier corresponding to a first I/O request of the plurality of I/O requests; and
assigning the first I/O request to a tier based at least in part on the tier assignment identifier corresponding to the first I/O request.

5. The method of claim 1, wherein assigning each I/O request to a tier further comprises:
detecting a tier assignment identifier corresponding to a first I/O request of the plurality of I/O requests;
generating a tier assignment metric corresponding to a first tier of the plurality of tiers, wherein the tier assignment metric indicates a quantity of I/O requests associated with the first tier; and
based at least in part of the tier assignment metric, assigning the first I/O request to a second tier of the plurality of tiers instead of the first tier.

6. The method of claim 5, wherein the second tier corresponds to a lower-latency execution path than the execution path corresponding to the first tier.

7. The method of claim 1, wherein assigning each I/O request to a tier further comprises:
detecting a tier assignment identifier corresponding to a first I/O request of the plurality of I/O requests;
generating a tier assignment metric corresponding to a first tier of the plurality of tiers, wherein the tier assignment metric indicates a quantity of I/O requests associated with the first tier;
wherein a second I/O request of the plurality of I/O requests is assigned to the first tier; and
based at least in part of the tier assignment metric, assigning the first I/O request to the first tier, and reassigning the second I/O request from the first tier to a second tier of the plurality of tiers.

8. The method of claim 1, wherein the particular kernel interface is associated with separate submission and completion queues.

9. The method of claim 1, wherein the particular kernel interface is an asynchronous I/O interface that a) comprises a ring buffer used for submitting and completing I/O requests; and b) allows for non-blocking I/O operations.

10. The method of claim 1, wherein assigning each request to a tier is performed based at least in part on one or more of:
one or more latency targets corresponding to the request being assigned; ;
one or more service level requirements corresponding to the request being assigned;
size of the request being assigned;
access patterns corresponding to requests similar to the request being assigned;
historical performance characteristics corresponding to requests similar to the request being assigned; and
a classification corresponding to the request being assigned.

11. One or more non-transitory computer-readable media comprising instructions that, when executed by one or more hardware processors, cause performance of operations comprising:
receiving, at an intermediary for dispatching I/O requests, a plurality of I/O requests;
assigning each request of the plurality of I/O requests to a tier of a plurality of tiers, wherein each tier of the plurality of tiers is associated with a corresponding execution path that includes a same particular kernel interface;
routing each I/O request of the plurality of requests to an I/O execution path corresponding to its assigned tier; and
executing I/O operations in each tier in the plurality of tiers using at least the particular kernel interface.

12. The non-transitory media of claim 11, wherein the operations further comprise:
dynamically adjusting one or more execution paths based at least in part on changing system conditions or workload characteristics.

13. The non-transitory media of claim 11, wherein a first execution path includes a polling operation and a second execution path does not include a polling operation.

14. The non-transitory media of claim 11, wherein assigning each I/O request to a tier further comprises:
detecting a tier assignment identifier corresponding to a first I/O request of the plurality of I/O requests; and
assigning the first I/O request to a tier based at least in part on the tier assignment identifier corresponding to the first I/O request.

15. The non-transitory media of claim 11, wherein assigning each I/O request to a tier further comprises:
detecting a tier assignment identifier corresponding to a first I/O request of the plurality of I/O requests;
generating a tier assignment metric corresponding to a first tier of the plurality of tiers, wherein the tier assignment metric indicates a quantity of I/O requests associated with the first tier; and
based at least in part of the tier assignment metric, assigning the first I/O request to a second tier of the plurality of tiers instead of the first tier.

16. A system comprising:
one or more hardware processors;
one or more non-transitory computer-readable media; and
program instructions stored on the one or more non-transitory computer-readable media which, when executed by the one or more hardware processors, cause the system to perform operations comprising:
receiving, at an intermediary for dispatching I/O requests, a plurality of I/O requests;
assigning each request of the plurality of I/O requests to a tier of a plurality of tiers, wherein each tier of the plurality of tiers is associated with a corresponding execution path that includes a same particular kernel interface;
routing each I/O request of the plurality of requests to an I/O execution path corresponding to its assigned tier; and
executing I/O operations in each tier in the plurality of tiers using at least the particular kernel interface.

17. The method of claim 1, wherein the operations further comprise:
dynamically adjusting one or more execution paths based at least in part on changing system conditions or workload characteristics.

18. The method of claim 1, wherein a first execution path includes a polling operation and a second execution path does not include a polling operation.

19. The method of claim 1, wherein assigning each I/O request to a tier further comprises:
detecting a tier assignment identifier corresponding to a first I/O request of the plurality of I/O requests; and
assigning the first I/O request to a tier based at least in part on the tier assignment identifier corresponding to the first I/O request.

20. The method of claim 1, wherein assigning each I/O request to a tier further comprises:
detecting a tier assignment identifier corresponding to a first I/O request of the plurality of I/O requests;
generating a tier assignment metric corresponding to a first tier of the plurality of tiers, wherein the tier assignment metric indicates a quantity of I/O requests associated with the first tier; and
based at least in part of the tier assignment metric, assigning the first I/O request to a second tier of the plurality of tiers instead of the first tier.
